(19) United States
(12) Patent Application Publication
(10) Pub. No.: US 2015/0249745 A1
(43) Pub. Date: Sep. 3, 2015

(54) SYSTEM AND METHOD FOR PROVIDING STATUS INFORMATION FOR GROUP COMMUNICATION LINES

(71) Applicant: Vonage Business Solutions, Inc., Atlanta, GA (US)

(72) Inventor: Randy Layman, Marietta, GA (US)

(73) Assignee: Vonage Business Solutions, Inc., Atlanta, GA (US)

(21) Appl. No.: 14/194,438

(22) Filed: Feb. 28, 2014

(51) Int. Cl. H04M 3/523

(52) U.S. Cl. CPC H04M 3/523

(57) ABSTRACT

A system and method are disclosed herein for indicating the status of a service queue and routing communications. The system maintains a server having at least a first service queue and second service queue. Each service queue comprises at least one or more individual agent device extensions. As calls come into the system, they are first handled by the first service queue. A server monitors performance parameters of the one or more individual agent extensions on a group communications line servicing the second service queue. A display device is provided for displaying the status of each agent in the second service queue based on the monitored performance parameters. The operator is able to use a switch board for transferring communications from the first service queue to the second service queue based on the indicated status of the second service queue.

### FIELD OF THE INVENTION

The present invention relates generally to group communication lines and, more particularly, to systems and methods for using busy lamp fields to indicate status information for group communication lines.

### BACKGROUND OF THE INVENTION

Traditionally, businesses and other organizations may provide customer support or sales through a team of agents. In a common setup, agents' phone lines are collectively managed and controlled by a PBX, and in many cases the phone lines for one group of agents are configured to be part of a group communication line managed by the PBX, such as a call queue or a call group. A group communication line is a feature common in PBX systems that allows a single call destination, such as a phone number or an extension number, to route calls to multiple extensions either simultaneously or sequentially or in some other controlled way. For example, it is typical for a customer support organization to use a call queue for incoming calls, such that the calls are queued in order and are then routed by the PBX to agent phone lines when the next agent becomes available.

In organizations using one or more group communication lines, it is typical to have many scenarios where a call is transferred to a group communication line. For example, an operator may answer a call and upon learning that the caller wishes to talk to customer support the operator might then transfer the call to the support call queue. In another example, a call initially routed to one group communication line such as a support call queue or a sales call group might then need to be transferred to technical support, which has its own separate call queue. In cases where transfers of this type are frequent, phone devices may be configured for fast transfer, for example an operator might have multiple configured quick dial buttons on a phone device that provide a way to transfer calls to specific lines without having to dial another line identifier such as an extension number.

In many instances, it is common for the person within the organization who makes the transfer to not have any information about the status of the group communication line. For example, an operator or agent who needs to transfer a call often has no idea whether the group communication line to which the call will be transferred is overloaded. In some instances, a system separate from the phone device may provide information about group communication lines, for example a software system connected to the PBX might provide an operator or agent with a display on their computer screen that shows the status of group communication lines. In some instances, a separate system might also provide an interface to initiate a call transfer to a group communication line, for example a software system connected to the PBX might allow an operator to select a group communication line through a user interface and initiate the transfer of a call. Providing information about the status of group communication lines can be very useful to allow users to choose alternate call routing when appropriate, but many users in many organizations do not have such information available to them.

This invention describes a new and unique way to indicate the status of one or more group communication lines through a phone device itself. This invention makes new use of busy lamp fields on phone devices that have traditionally been used to indicate to an operator or an agent the status of individual phone lines within an organization and also provides associated quick dial capabilities for each line. This method can significantly improve call-handling times and business operations as operators or agents are provided critical status information directly and clearly through the phone device without needing to rely on separate systems and operators or agents can also perform quick dial and transfer to group communication lines where the status indicated is most favorable.

The present invention meets one or more of the above-referenced needs as described herein in greater detail.

### SUMMARY OF THE INVENTION

The present invention relates generally to group communication lines and, more particularly, to a system and method for using busy lamp fields for providing status information for group communication lines. Embodiments disclosed herein allow an operator or agent to determine the status of a call queue or call group or other group communication line visually, via a phone device's assigned busy lamp field, so the operator can make appropriate decisions about whether or not to transfer calls to the associated group communication line and then can take advantage of the device's associated quick dial and transfer capability. Briefly described, aspects of the present embodiments include the following.

In a first aspect, the present embodiment provides a system and method for indicating the status of a service queue and routing communications. The system maintains a server having at least a first service queue and second service queue. Each service queue comprises at least one or more individual agent device extensions. When calls come into the system, they are first handled by the first service queue. A server monitors performance parameters of the one or more individual agent extensions on a group communications line servicing the second service queue. A display device is provided for displaying the status of each agent in the second service queue based on the monitored performance parameters. The operator is able to use a switch board for transferring communications from the first service queue to the second service queue based on the indicated status of the second service queue.

In a further embodiment, the monitored performance parameters include expected hold time for the service queue, historical data, type of call, and status of the caller. Furthermore, the status of the caller can include amount of time the caller has been waiting, type of service the caller is requesting, and the type of service plan to which the caller has subscribed. The indicated status can also include information: that a line is idle; that a line is active or in use; that a line is active and operating at optimal performance; or that line is active but operating at poor performance. In another embodiment, an indicated status can include indicators that alert an operator to the expected hold time of a call, maximum hold time of a call, and average hold time of a call.

In still another embodiment, status indicators can include information specific to an agent handling a call including the particular agents average call handle time, the type of issue a particular agent can address, and the amount of time already spent on a call by an agent. The lamp field display can provide additional status indicators including images, icons, words, or other visual indicators. The lamp field display can also provide additional status indicators including an individual agent's performance metrics.

The above features as well as additional features and aspects of the present invention are disclosed herein and will become apparent from the following description of preferred embodiments of the present invention.

This summary is provided to introduce a selection of aspects and concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is a block diagram of an exemplary embodiment of a system for using busy lamp fields for group communications lines;

FIG. 2 is a block diagram of an exemplary embodiment of a busy lamp field display;

FIG. 3 is a flowchart of an exemplary embodiment of a method for using busy lamp fields for group communications lines; and

FIG. 4 is a block diagram of an exemplary computing environment that may be used in conjunction with example embodiments and aspects.

### DETAILED DESCRIPTION

Before the present methods and systems are disclosed and described in greater detail hereinafter, it is to be understood that the methods and systems are not limited to the disclosed methods, components, or implementations. It is also to be understood that the terminology used herein is for the purpose of describing particular aspects and embodiments only and is not intended to be limiting.

As used in the specification and the appended claims, the singular forms “a,” “an,” and “the” include plural referents unless the context clearly dictates otherwise. “Optional” or “optionally” means that the subsequently described event or circumstance may or may not occur, and the description includes instances where the event or circumstance occurs and instances where it does not.

Throughout the description and claims of this specification, the word “comprise” and variations of the word, such as “comprising” and “comprises,” mean “including but not limited to,” and are not intended to exclude, for example, other components, integers or steps. “Exemplary” means “an example of” and is not intended to convey an indication of preferred or ideal embodiment. “Such as” is not used in a restrictive sense, but for explanatory purposes.

Disclosed herein are components that can be used to perform the disclosed methods and systems. It is understood that when combinations, subsets, interactions, groups, etc. of these components are disclosed that although specific reference to each various individual and collective combinations and permutations cannot be explicitly disclosed, each is specifically contemplated and incorporated herein, for all methods and systems. This applies to all aspects of this specification including, but not limited to, steps in disclosed methods. Thus, if there are a variety of additional steps that can be performed, it is understood that each of the additional steps can be performed with any specific embodiment or combination of embodiments of the disclosed methods.

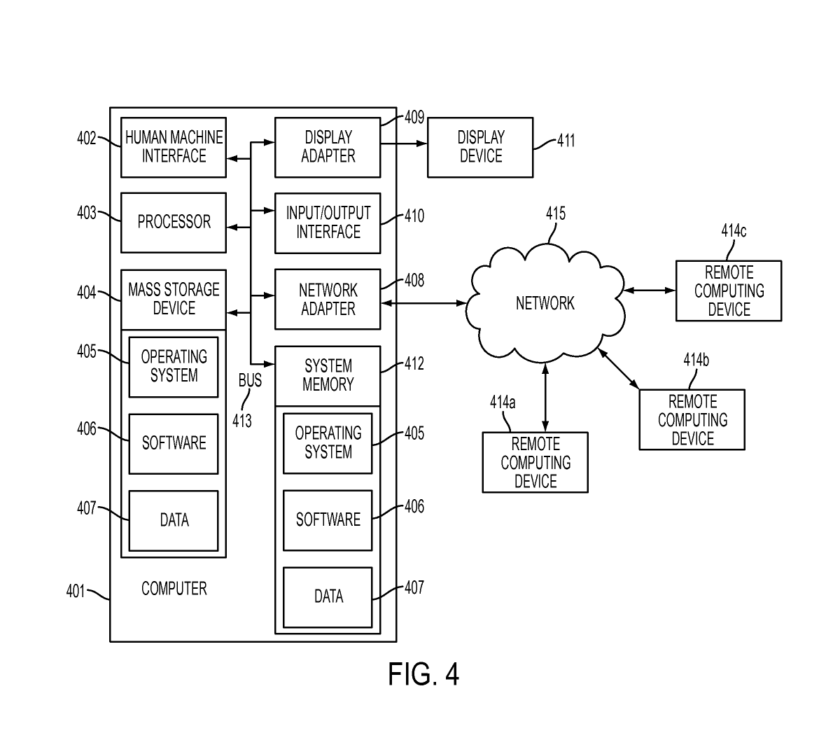

As will be appreciated by one skilled in the art, the methods and systems may take the form of an entirely new hardware embodiment, an entirely new software embodiment, or an embodiment combining new software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, non-volatile flash memory, CD-ROMs, optical storage devices, and/or magnetic storage devices. An exemplary computer system is detailed in the discussion of FIG. 4 below.

Embodiments of the methods and systems are described below with reference to block and flowchart diagrams of methods, systems, apparatuses and computer program products. It will be understood that each block of the block diagrams and flowchart diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks contained in the block diagram and flowchart diagrams support combinations of means for performing the specified functions, combinations of steps for performing the specified functions and program instruction means for performing the specified functions. It will also be understood that each block of the block diagram and flowchart diagrams, and combinations of blocks in the block diagram and flowchart diagrams, can be implemented by special purpose hardware-based computer systems that perform the specified functions or steps, or combinations of special purpose hardware and computer instructions.

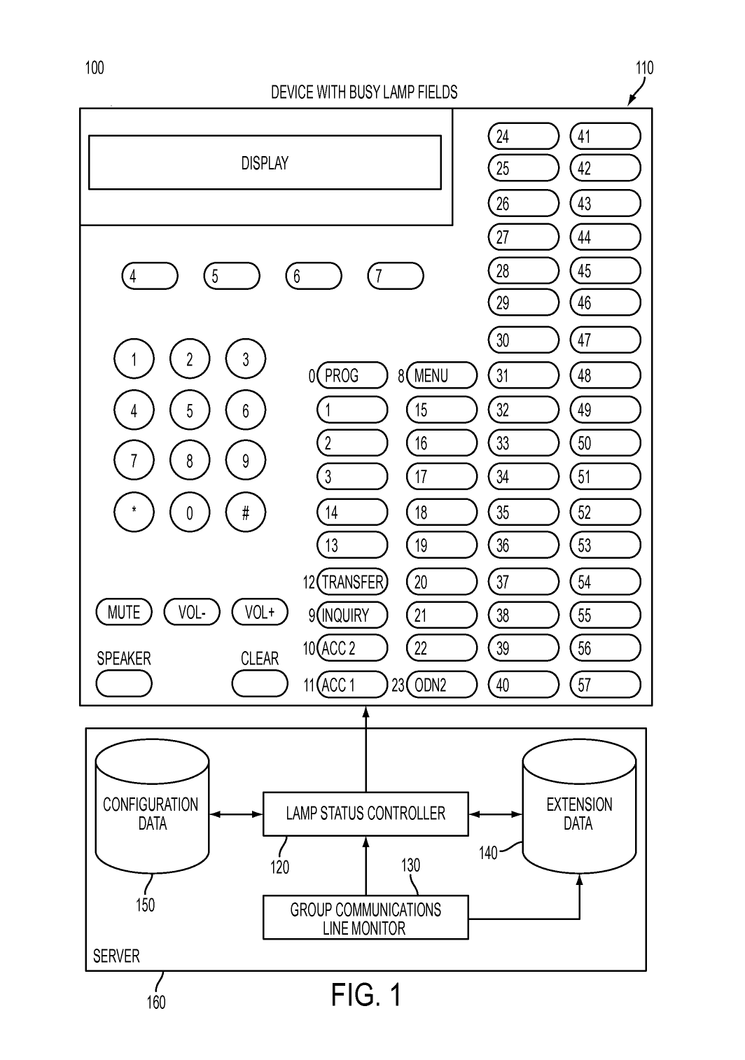

FIG. 1 is a block diagram of an exemplary system 100 for using a busy lamp field for providing status information for group communication lines. The block diagram in FIG. 1 provides details of the various aspects of an exemplary embodiment in which the present methods and systems can operate. In an exemplary embodiment, the busy lamp field display 110 is monitored by an operator who is able to determine the status of an extension or a group communication line by simply noticing the properties of a light, lamp or other indicator associated with the extension or group communication line. In fact, these indicators can display the status of an individual caller, a group of callers, and/or a “tier” of callers. However, in the exemplary embodiment, the busy lamp field display 110 allows an operator to monitor and manage group communication lines.

In the exemplary embodiment, lamps 1-57 on the busy lamp field display 110 are associated with one or more group communication lines. A Lamp Status Controller 120 is part of a computer Server 160 or similar computing device that polls or receives via push monitoring, phone or SIP Device, Extension Data 140 indicating the current state of various phone or SIP device extensions on the group communication line. The Extension Data 140 is stored within a computer storage medium that is accessible by the Server 160. This Extension Data 140 is gathered via a Group Communications Line Monitor 130, which can pull data from a variety of systems, such as a PBX, or an activity logging system, or can even be manually entered by a party such as manager or administrator. Monitoring Extension Data 140 allows the system 100 to more accurately indicate the particular state and performance of the call queue or other communication lines. This Extension Data 140 can include a variety of data elements such as the number of agents currently active, the average talk time of agents, the average wait time of callers, the number of callers waiting, or the number of abandoned (unanswered) calls within a given time period. The status of each individual agent or extension can also be monitored and analyzed for display on the busy lamp field display 110.

Further in FIG. 1, the Lamp Status Controller 120 also relies upon Configuration Data 150 to establish what performance parameters are measured, what performance parameters are acceptable, as well as the methods and algorithms necessary for gathering this data. Therefore, the Group Communications Line Monitor 130 queries the Configuration Data 150 to determine which performance parameters to measure and how to measure therm. The Lamp Status Controller 120 relies on the Configuration Data 150 in order to interpret the Extension Data 140, so that it can indicate via the Busy Lamp Field Display 110, when a state change has occurred.

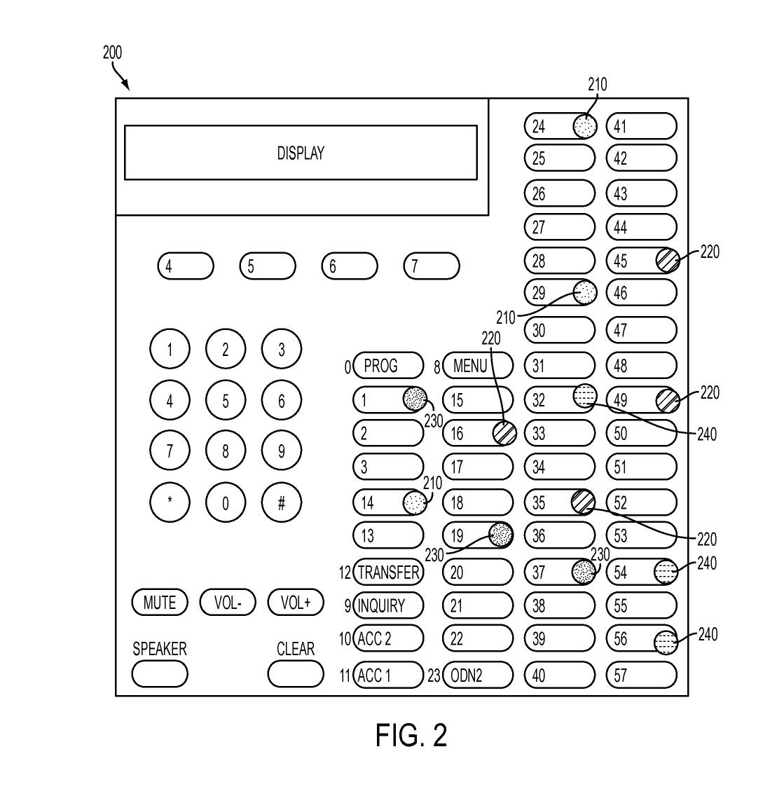

Turning now to FIG. 2 in view of FIG. 1, an illustration of a Busy Lamp Field 200 within the Busy Lamp Field Display 110 is provided. When a Busy Lamp Field 200 is associated with a call queue or a group communication line, the Lamp Status Controller 120 updates the Busy Lamp Field 200 with any state changes for each extension among the group communication line. For example, in an exemplary embodiment, if a call comes into the switch board, an operator takes the call and determines where the call should be routed. The operator is quickly able to determine the status of each agent by looking at the status indicator lights (1-57 in this example) for each agent's extension on the busy lamp field. In the exemplary embodiment, all agents may be busy when the call initially comes in; however a few seconds later an agent may hang up their current call and indicate that they are ready for another call. When the agent indicates this, there is status change for that agent's extension on the Busy Lamp Field 200 to indicate the agent is available. This status change is updated on the Busy Lamp Field 200 using the Lamp Status Controller 120. Although the discussion here is described in terms of one or more individual agents, the status indicator lights 1-57 could also represent a group of communication lines or tiers of agent extensions.

Further in FIGS. 1 and 2, the Lamp Status Controller 120 is alerted to a change in status for each agent's extension via the Group Communications Line Monitor 130. In an exemplary embodiment, the Lamp Status Controller 120 drives the display of the Busy Lamp Field 200 in accordance with the display characteristics associated with the particular state of each agent's phone extension. In a further embodiment, the Lamp Status Controller 120 can also drive the display of the Busy Lamp Field 200 in accordance with the display characteristics associated with the particular state of a group or tier of agent's phone extensions. A state change can be indicated in one of the Busy Lamp Field's 200 lamps 1-57 by the continuous monitoring of the group communication lines.

The display characteristics used to indicate the various states of an agent's extension might be defined in Configuration Data 150 or fixed within the Lamp Status Controller 120. The number and types of states displayed by the Busy Lamp Field 200 device can vary based on as much variety as the Busy Lamp Field device 200 will allow. For example, some Busy Lamp Field devices 200 might only allow lamps one of two colors, such as green or red, with an additional option being a blinking lamp. Therefore, this would support four distinct visual lamp status indicators: green 210, red 220, green blinking 230, red blinking 240. These could be associated with distinct states related to a call queue such as: green 210 for indicating a call queue that has agents ready and waiting and blinking green 230 for indicating a call queue where all agents are currently on a call; however, performance monitoring data indicates at least one agent will be available soon. Alternatively, a red blinking 240 indicator may be used for a call queue where all agents are currently on a call and performance monitoring data indicates the agents are not within good performance parameters (e.g. quickly resolving calls); (steady) red 220 can be used for a call queue where no agents are currently logged in (so no one is there to take calls). Therefore, the color, blinking or non-blinking state of each lamp can be used to provide a variety information regarding the performance metrics and analytics of each individual extension, group of extensions or communications lines.

In a further embodiment, the variety of states and status indicators are enhanced when the Busy Lamp Field device 200 allows other colors, for example; or when the Busy Lamp Field device 200 allows a variety of alternative images, icons, words, numbers, or other visual indicators to be displayed in association with each group communication line or agent's extension. These other indicators can be used to provide a variety of information such as performance metrics and analytics of individual agents, groups of agents or communications lines. In a further embodiment, this invention can be extended to other group communication lines such as call groups or conference bridges. In the case of call groups, this may be useful for monitoring performance metrics for call queues, while providing a visual indicator as to a call group's status. In the case of conference bridges, it could be useful to indicate which bridges are empty and which ones are full to capacity or overloaded.

In a further embodiment, the performance of agents in a specific call queue or call group can be rated. This rating could be used to determine the state indicated by a Busy Lamp Field 200. For example, if the agents are salespeople, it is useful to know which call queue or call group has agents closing the largest number of deals, which could be determined through monitoring data from a CRM, purchasing, or order system. In another embodiment, if an organization has multiple communication lines, for example, if there are multiple groups of salespeople or support personnel associated to separate call queues, then an operator with visual indicators on a Busy Lamp Field device 200 could transfer calls to the call queue where performance monitoring data indicates that the agents are performing the best.

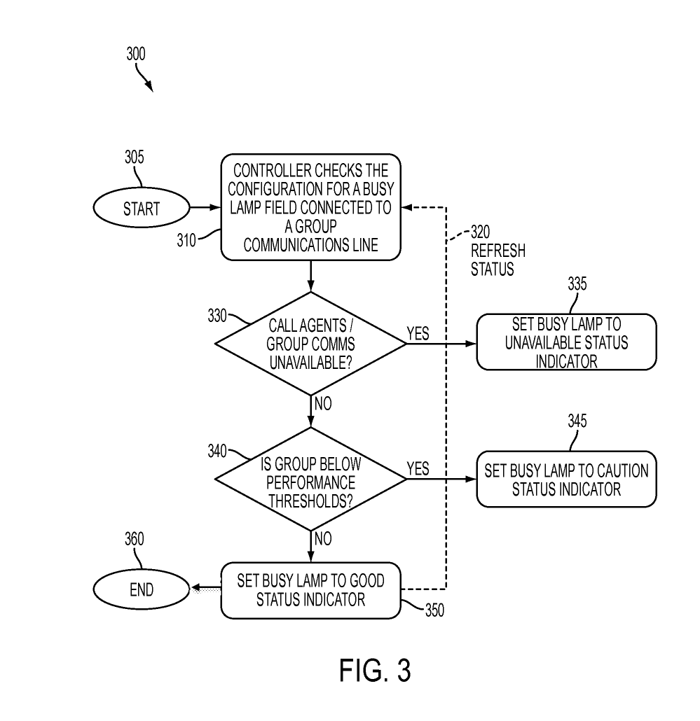

Turning now to FIG. 3, a method 300 for using busy lamp fields for providing status information for group communication lines is disclosed. The method begins at step 305 when the Busy Lamp Field system 100 is activated and initialized. In fact, the Busy Lamp Field display 200 can be updated each time a new incoming call is received. Once the Busy Lamp Field system 100 is activated, the system initializes itself and moves on to step 310.

At step 310, the Lamp Status Controller 120 checks Configuration Data 150 for a Busy Lamp Field 200 connected to one or more group communications lines. Further at step 310, the Lamp Status Controller 120 queries the device busy lamp field Configuration Data 150 in order to set status thresholds and parameters for the state change indicators. Thresholds within the Configuration Data 150, or thresholds defined within the implementation of the Lamp Status Controller 120, define states for the call queue and/or other group communication lines based on one or more specific data elements. For example, within the device busy lamp field Configuration Data 150, one state of a call queue might be defined “unavailable” which would equate to zero agents active. Another state might be “overloaded,” which could equate to a combination of number of callers and abandon rates exceeding given thresholds. In other embodiments, states can include information specific to an agent handling a call including the particular agent's average call handle time, the type of issue a particular agent can address, and amount of time already spent on a call by an agent. The Lamp Status Controller 120 can also utilize other state information including an individual agent's performance metrics when updating the Busy Lamp Field display 200. In the various embodiments, an unlimited number of states might be defined; however it is only practical to have as many states as can be visually indicated clearly by the Busy Lamp Field device 200. Once the Configuration Data 150 has been queried, the method moves on to step 330.

At step 330, the Lamp Status Controller 120 queries the Group Communications Line Monitor 130 to determine if there is an available agent or communications line from among a plurality of agents or group communication lines. The Group Communications Line Monitor 130 checks the status of each extension within the group communications line and returns the status of all agents or all available agents to the Lamp Status Controller 120. If the Group Communications Line Monitor 130 indicates that an agent is unavailable, the method will move on to step 335.

At step 335, the Group Communications Line Monitor 130 has indicated that there are no agents available. The Lamp Status Controller 120 receives data that no agents are available on the group communications line. Therefore, the Lamp Status Controller 120 proceeds to update the status of the each of the Busy Lamp Field's 200 lamps (1-57). The Busy Lamp Field's 200 lamps are updated to indicate agents or communications lines that are unavailable. In an exemplary embodiment, this is done by changing the lamp associated with the agent's extension or group communications line to glow red 220 or blinking red 240. The Lamp Status Controller 120 can change an agent's extension light to red and blinking on the Busy Lamp Field 200 device if agents are currently on a call but performance monitoring data, such as number of callers waiting and wait times, are below threshold performance parameters. Therefore, in the exemplary embodiment, the operator may avoid transferring an incoming call to an agent already on a call—with a blinking red status light—because prior performance has indicated that the agent (or agents on a communications line) has not been able to quickly resolve one call and move on to the next. However, if agents are available, the method moves on to step 340.

At step 340, the Lamp Status Controller 120 queries the Group Communications Line Monitor 130 to determine if available agents are performing well. If the agents are performing well, wherein error and latency thresholds have not been exceeded, the method will move on to step 350. However, if performance monitoring data is not within good performance parameters the method will move to step 345.

At Step 345, the Lamp Status Controller 120 updates the display of the Busy Lamp Field 200 to caution. The caution status is used when the Group Communications Line Monitor 130 has determined that the agents on a line are not performing well, such as by exceeding error and hold time thresholds, the Lamp Status Controller 120 can update the status of those lines on the Busy Lamp Field 200 display. For example, in an exemplary embodiment, the Lamp Status Controller 120 may update each agent's or communications status on the Busy Lamp Field 200 display to blinking green. The Lamp Status Controller 120 can change an extension light to green and blinking 230 on the Busy Lamp Field 200 device if all agents are currently on a call but performance monitoring data such as number of callers waiting and wait times are not within good performance parameters. Therefore, in the exemplary embodiment, the operator can transfer an incoming call to an agent already on a call, with a blinking green status light, because the agent is available. However, the operator may also opt to transfer the call to a different agent or communications group because prior performance of the blinking green extension has indicated that the agent or agents have not been able to quickly resolve one call and move on to the next.

Finally at step 350 if the Group Communications Line Monitor 130 indicates that agents are currently available and are actually well within performance thresholds, then the Lamp Status Controller 120 is directed to update the lamps 1-57 associated with that extension's status accordingly (e.g., with a solid green indicator lamp).

After step 350, the method may rely on the Group Communications Line Monitor 130 to continually update the Busy Lamp Field 200 Display with status information. It may also wait for the next incoming call to restart steps 305-350. Alternatively, in an exemplary embodiment, the method both continually updates and refreshes its status 320 by returning to step 310. The method ends at step 360.

Turning now to FIG. 4, one skilled in the art will appreciate that the systems and methods disclosed herein can be implemented via a general-purpose computing device in the form a computer or computer server 401 (herein after “computer”). The components of the computer 401 can comprise, but are not limited to, one or more processors or processing units 403, a system memory 412, and a system bus 413 that couples various system components including the processor 403 to the system memory 412. In the case of multiple processing units 403, the system can utilize parallel computing.

The system bus 413 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Private Branch Exchange (PBX) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 413, and all buses specified in this description can also be implemented over a wired or wireless network connection and each of the subsystems, including the processor 403, a mass storage device 404, an operating system 405, software 406, data 407, a network adapter 408, system memory 412, an input/output interface 410, a display adapter 409, a display device 411, a human machine interface 402, can be contained within one or more remote computing devices 414a,b,c at physically separate locations, connected through buses of this form, in effect implementing a fully distributed system.

The computer 401 typically comprises a variety of computer readable media. Exemplary readable media can be any available media that are accessible by the computer 401 and comprise, for example, both volatile and non-volatile media, as well as, removable and non-removable media. The system memory 412 comprises computer readable media in the form of volatile memory, such as random access memory (RAM), and/or non-volatile memory, such as read only memory (ROM). The system memory 412 may contain data such as media, video, audio, or other data 407 and/or program modules such as an operating system 405 and software 406 capable of manipulating, translating, transcoding, or otherwise editing the data 407 that are immediately accessible to and/or presently operated on the by the processing unit 403.

In another aspect, the computer 401 can also comprise other removable/non-removable, volatile/non-volatile computer storage media. By way of example, FIG. 4 illustrates a mass storage device 404, which can provide non-volatile storage of computer code, computer readable instructions, data structures, program modules and other data for the computer 401. For example, a mass storage device 404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 404, including by way of example, an operating system 405 and hosted VoIP PX software 406. Both the operating system 404 and hosted VoIP PX software 406 (or some combination thereof) can comprise elements of the programming and the hosted VoIP PX software 406. Media, video, audio, or other data 407 can be stored in any of one or more databases known in the art. Examples of such databases comprise, DB2®, Microsoft® Access, Microsoft® SQL Server, Oracle®, MySQL, PostgreSQL, and the like. The databases can be centralized or distributed across multiple systems. Examples of hosted VoIP PX software include Asterisk®, FreeSwitch®, or Microsoft Lync® server software.

In another aspect, the user can enter commands and information into the computer 401 via client device or an input device (not shown). Example of such input devices comprise a keyboard, pointing device (e.g., a “mouse”), a microphone, a joystick, a scanner, tactile input devices such as gloves, and other body coverings, and the like. These and other input devices can be connected to the processing unit 403 via a human machine interface 402 that is coupled to the system bus 413, but also can be connected by other interface and bus structures, such as a parallel port, game port, IEEE 1394 Port (also known as a Firewire port), a serial port, or a universal serial bus (USB).

In yet another aspect, a display device 411 can also be connected to the system bus 413 via an interface, such as a display adapter 409. It is contemplated that the computer 401 can have more than one display adapter 409, and the computer 401 can have more than one display device 411. For example, a display device can be a monitor, an LCD (Liquid Crystal Display), or a projector. In addition to the display device 411, other output peripheral devices can comprise components such as speakers (not shown) and a printer (not shown), which can be connected to the computer 401 via input/output interface 410. Any step and/or result of the methods can be output in any form to an output device. Such output can be any form of visual representation, including but not limited to, textual, graphical, animation, audio, tactile, and the like. The display 411 and computer 401 can be part of one device, or separate devices.

The computer 401 can operate in a networked environment using logical connections to one or more remote computing devices 414a,b,c. By way of example, a remote computing device can be a personal computer, portable computer, smartphone, softphone, client device, a server, a router, a network computer, a peer device or other common network node, and so on. Logical connections between the computer 401 and remote computing device 414a,b,c can be made via a network 415, such as a local area network (LAN) and or a general wide area network (WAN). Such network connections can be through a network adapter 408. A network adapter 408 can be implemented in both wired and wireless environments. Such networking environments are conventional and commonplace in dwellings, offices, enterprise-wide computer networks, intranets, and the Internet.

For purposes of illustration, application programs and other executable program components such as the operating system 405 are illustrated herein as discrete blocks, although it is recognized that such programs and components reside at various times in different storage components of the computing device 401, and are executed by the data processor(s) of the computer. An implementation of media manipulation software 406 can be stored on or transmitted across some form of computer readable media. Any of the disclosed methods can be executed by computer readable instructions embodied on computer readable media. Computer readable media can be any available media that can be accessed by a computer. By way of example and not meant to be limiting, computer readable media can comprise “computer storage media” and “communications media.” “Computer storage media” comprises volatile and non-volatile, removable and non-removable media implemented in any methods or technology for storage of information such as computer readable instructions, data structures, program modules, or other data. Exemplary computer storage media comprises, but is not limited to RAM, ROM, EEPROM, flash memory or memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence (AI) techniques such as machine learning and iterative learning. Examples of such techniques include, but are not limited to, expert systems, case-based reasoning, Bayesian networks, behavior-based AI, neural networks, fuzzy systems, evolutionary computation (e.g. genetic algorithms), swarm intelligence (e.g. ant algorithms), and hybrid intelligent system (e.g. expert interference rules generated through a neural network or production rules from statistical learning).

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, mobile phones, softphones, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for indicating the status of one or more group communication lines and routing communications to individual agent extensions within group communications line, comprising:
providing a first service queue and second service queue,
each service queue comprises one or more of the individual agent extensions,
monitoring performance parameters of the one or more individual agent extensions servicing the second service queue;
indicating a status of the second service queue based on the monitored performance parameters; and
transferring incoming communications from the first service queue to the second service queue based on the indicated status of the second service queue.

2. The method according to claim 1, wherein the monitored performance parameters comprise expected hold time for the service queue, historical data, type of call, status of the caller.

3. The method according to claim 2, wherein the status of the caller includes amount of time the caller has been waiting, type of service the caller is requesting, and type of service plan to which the caller has subscribed.

4. The method according to claim 1, wherein the indicated status includes information that a line is idle, that a line is active or in use, that a line is active but at optimal performance, that a line is active but at poor performance.

5. The method according to claim 1, wherein an indicated status includes indicators that alert an operator to the expected hold time of a call, maximum hold time of a call, and average hold time of a call.

6. The method according to claim 1, wherein an indicated status includes information specific to an agent handling a call including the particular agent's average call handle time, the type of issue a particular agent can address, and amount of time already spent on a call by an agent.

7. A system for indicating the status of a service queue and routing communications, comprising:
a server having at least a first service queue and second service queue, wherein
each service queue comprises at least one or more individual agent device extensions,
initial calls are handled by the first service queue;
a server for monitoring performance parameters of the one or more individual agent extensions on a group communications line servicing the second service queue;
a display device for displaying the status of each agent in the second service queue based on the monitored performance parameters; and
a switch board for transferring communications from the first service queue to the second service queue based on the indicated status of the second service queue.

8. The system according to claim 7, wherein the monitored performance parameters include expected hold time for the service queue, historical data, type of call, status of the caller.

9. The system according to claim 8, wherein the status of the caller includes amount of time the caller has been waiting, type of service the caller is requesting, and type of service plan to which the caller has subscribed.

10. The system according to claim 7, wherein the indicated status includes information that a line is idle, that a line is active or in use, that a line is active but at optimal performance, that a line is active but at poor performance.

11. The system according to claim 7, wherein an indicated status includes indicators that alert an operator to the expected hold time of a call, maximum hold time of a call, and average hold time of a call.

12. The system according to claim 7, wherein an indicated status includes information specific to an agent handling a call, including the particular agent's average call handle time, the type of issue a particular agent can address, and amount of time already spent on a call by an agent.

13. A telephony system for indicating the status of a service queue and routing communications, comprising:
a server maintaining at least a first service queue and second service queue, wherein each service queue comprises a plurality of individual agent extensions and wherein initial calls are handled by the first service queue;
a performance monitoring system for monitoring the performance parameters of each individual agent extension in the second service queue;
a lamp field display for indicating a status of each individual agent extension in the second service queue based on the monitored performance parameters; and
a switch board for transferring communications from the first service queue to the second service queue based on the indicated status of each individual agent extension in the second service queue.

14. The system according to claim 13, wherein the monitored performance parameters include expected hold time for the service queue, historical data, type of call, status of the caller.

15. The system according to claim 14, wherein the status of the caller includes amount of time the caller has been waiting, type of service the caller is requesting, and type of service plan to which the caller has subscribed.

16. The system according to claim 13, wherein the indicated status includes information that a line is idle, that a line is active or in use, that a line is active but at optimal performance, that a line is active but at poor performance.

17. The system according to claim 13, wherein an indicated status includes indicators that alert an operator to the expected hold time of a call, maximum hold time of a call, and average hold time of a call.

18. The system according to claim 13, wherein an indicated status includes information specific to an agent handling a call including the particular agent's average call handle time, the type of issue a particular agent can address, and amount of time already spent on a call by an agent.

19. The system according to claim 13, wherein the lamp field display provides additional status indicators including images, icons, words, or other visual indicators.

20. The system according to claim 13, wherein the lamp field display provides additional status indicators including an individual agent's performance metrics.
